(19) United States
(12) Patent Application Publication
(10) Pub. No.: US 2014/0295758 A1
(43) Pub. Date: Oct. 2, 2014

(54) DOCKING STATION FOR A HANDHELD TELECOMMUNICATION DEVICE

(71) Applicant: Thomas Pedersen, Gorlose (DK)

(72) Inventor: Thomas Pedersen, Gorlose (DK)

(21) Appl. No.: 13/993,430

(22) PCT Filed: Dec. 14, 2010
(86) PCT No.: PCT/EP10/69609

§ 371 Date: Aug. 30, 2013

(51) Int. Cl. H04M 1/725; H04W 4/00

(52) U.S. Cl. CPC H04M 1/72527; H04W 4/008
USPC 455/41.2

(57) ABSTRACT

A docking station (1) for a handheld telecommunication device (2), such as a mobile phone or a smartphone, which telecommunication device (2) comprises a first short-range transceiver (4) adapted to communicate according to a first radio standard. The docking station (1) comprises a holder (5) for holding the telecommunication device (2) and sensing means (6) for detecting if the telecommunication device (2) is held by the holder (5). Upon detecting that the telecommunication is held by the holder (5) the docking station (1) provides an activating signal, which activates a second short-range transceiver (7; 8) according to the first radio standard. The second short-range transceiver (7; 8) is comprised by the docking station (1) or a second device (3) connected to the docking station (1). The invention also relates to a docking system (9) comprising such a docking station (1).

### TECHNICAL FIELD

The invention relates to a docking station for a handheld telecommunication device, such as a mobile phone or a smartphone, which telecommunication device comprises a first short-range transceiver adapted to communicate according to a first radio standard, wherein the docking station comprises a holder for holding the telecommunication device, and sensing means for detecting, that the telecommunication device is held by the holder.

### BACKGROUND ART

Today there exist many different ways of communicating via modern technology, such as PSTN telephony, IP telephony and mobile telephony, SMS, instant messaging (chat), video conferencing, voice-mail, presence information etc. It is common for people to have both a mobile phone, and a desk phone/soft phone. A mobile phone is very practical when the user is away from his desk, but when he is working at his desk he may in many cases prefer to use a desktop phone or a soft phone. He may also prefer to use a headset, as this allows him to simultaneously operate his computer, write on a paper, looking in drawers with both hands etc. It may also be desirable that the user's presence status on computer or telecommunications network is updated, when the user arrives at his desk. Presence status is real time information about a person's ability and willingness to communicate. Other persons on the same network or connected to the same presence service provider can be updated real time with presence status of his contacts. All this relates to what is termed “unified communications”. An example of a unified communications system is Microsoft Lync.

US 2010/0173672 A1 discloses a mobile phone that automatically change operation mode between handset mode and speakerphone mode when the mobile phone is docked in a docking station.

WO 2004/038887 discloses an inductive recharging station for contactless recharging of a mobile phone. The mobile phone comprises a receiver for receiving power from the recharger, which receiver comprises means for detecting proximity to the recharger. Proximity detection is used for changing the state of the mobile phone—f. ex. start of synchronization via a Bluetooth transceiver in the recharger.

US 2010/0039066 discloses an inductive charging device with load detection means which detect the presence of a power receiver coil within the inductive range of an inductor. If such presence is detected, the charging device starts charging.

### DISCLOSURE OF INVENTION

The object of the invention is to provide a new and easy way of routing audio from a telecommunication device to another device by means of a docking station. The docking station according to the invention is characterized in that the docking station upon detecting that the telecommunication is held by the holder provides an activating signal, which activates a second short-range transceiver according to the first radio standard, which second short-range transceiver is comprised by the docking station or a second device connected to the docking station. If the first and second short-range transceivers are paired and the telecommunication device is set to auto-connect when within range of the second short-range receiver, the audio to and/or from the telecommunication device is automatically routed to/from another device, which could be a handset or speakerphone providing wireless communication for the user when the telecommunication device is placed in/on the holder. Thus, the user only has to place the telecommunication device in/on the holder when he arrives at his desk.

The sensing means may comprise a weight sensor, which is adapted to sense, that an object has been placed on the holder. Other simple means, such as optical sensors or mechanical levers could also be used. Also, a detector for detecting emitted radio waves from the first short-range transceiver or a long-range transceiver, f. ex. a GSM transceiver, may be used for sensing the telecommunication device being arranged on the holder. In this case, the sensitivity should be adjusted accordingly, so that docking is not detected unless the telecommunication is placed on the holder.

The docking station may be plate-shaped and comprise a top-surface adapted to support the entire back side of the telecommunication device.

According to the invention, the docking station may comprise an inductive charging transmitter circuit for charging a telecommunication device comprising a corresponding inductive charging receiver circuit, when the telecommunication device is supported by the holder. In this way both charging and wireless audio routing can be obtained by simply placing the telecommunication device on the holder.

The second short-range transceiver can be comprised by the docking station.

In this case, the docking station may comprise an audio socket for output and/or input of audio signals, which are transmitted between the first short-range transceiver and the second short-range transceiver. Thus, a corded headset, a headset base or a speakerphone can be connected by a cable to this audio socket.

The docking station itself may comprise a speaker for emitting audio based on signals transmitted from the first short-range transceiver to the second short-range transceiver. In this case, the docking station can be used as speaker or a music player. In the latter case, the docking station preferably comprises two speakers for stereo playback.

In the case that the docking station is used as a speakerphone, it preferably comprises a microphone for converting sound to an audio signal to be transmitted from the second short-range transceiver to the first short-range transceiver.

The docking station may also or alternatively comprise a headset cradle for docking a wireless headset with a headset transceiver.

In this case, the second short-range transceiver can be adapted to simultaneously establish a first radio link with the first short-range transceiver and the headset transceiver, such that two-way communication can be established between the telecommunication device and the headset.

The second short-range transceiver may be comprised by the docking station and preferably be a Bluetooth-transceiver as Bluetooth is very common in handheld telecommunication devices today.

The invention also relates to a docking system comprising a docking station which comprises the second short-range transceiver and wherein the docking system also comprises a headset system, which headset system comprises a headset base and a wireless headset, and wherein the docking station and the headset base are electrically connected by a cable.

Alternatively, the docking system may be embodied such that the second short-range transceiver is comprised by the headset system.

In this case, the second short-range transceiver may be comprised by the headset base.

The invention also relates to a docking system comprising a docking station, wherein the second short-range transceiver is comprised by a personal computer which is connected to the docking station by a cable, such as a USB-cable.

### BRIEF DESCRIPTION OF THE DRAWINGS

The invention is explained in detail below with reference to the drawings illustrating embodiments of the invention and in which

FIG. 1 is a perspective view of a docking station and a docking system according to the invention,

FIG. 2 is a diagram showing a docking station according to a first embodiment of the invention and a docking system according to a first embodiment of the invention,

FIG. 3 is a diagram showing a docking station according to a second embodiment of the invention and a docking system according to a second embodiment of the invention,

FIG. 4 is a diagram showing a docking system according to third embodiment of the invention,

FIG. 5 is a diagram showing a docking system according to a fourth embodiment of the invention,

FIG. 6 is a diagram showing a docking system according to a fifth embodiment of the invention,

FIG. 7 is a diagram showing a docking station according to a third embodiment of the invention,

FIG. 8 is a diagram showing a docking station according to a fourth embodiment of the invention,

FIG. 9 is a diagram showing a docking station according to a fifth embodiment of the invention,

FIG. 10 is a diagram showing a docking station according to a sixth embodiment of the invention,

FIG. 11 is a flowchart showing operation of the docking station/docking system when a telecommunication device is docked, and

FIG. 12 is a flowchart showing operation of the docking station/docking system when a telecommunication device is undocked.

### MODES FOR CARRYING OUT THE INVENTION

It should be noted, that the drawings are schematic and only elements essential for the explanation of the invention are disclosed here. Many details, which are well known and easy to implement for a skilled person to implement are left out for clarity reasons.

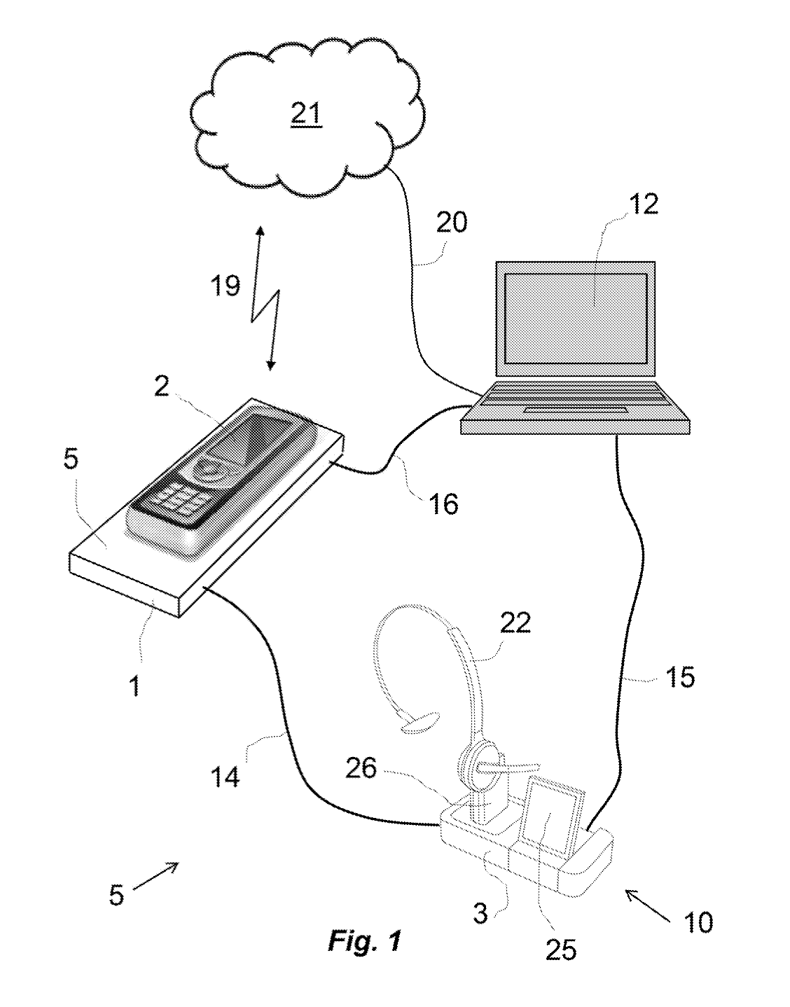

FIG. 1 discloses a docking system 9 according to the invention. The docking system 9 comprises a docking station 1 and a wireless headset system 10. The docking station 1 is intended for docking a handheld telecommunication device, such as mobile phone 2, which comprises a Bluetooth transceiver. The mobile phone 2 is docked by being placed on the top surface 5 of the docking station. The docking station 1 and the headset system 10 are connected by a cable 14, the function of which depends on the configuration of the docking station 1 and the headset system 10. The docking station 1 is also connected by a cable 16 to a computer 12. The computer 12 is by means of connection 20 connected to an external communications network 21. The external communications network 21 is a world-wide network comprising the public switched telephone network (PSTN), which is the network of the world's public circuit-switched telephone networks including fixed as well as mobile phones, and the Internet, which is the network of the world's public IP-based packet-switched networks. In addition, the mobile phone 2 is connected to the external communications network 21 by means of a GSM link 19. The headset system 10, which is wireless and comprises a headset base 3 with a touch display 25 and a headset 22, which rests in a cradle 26 extending from the headset base 3A. The headset base 3A is connected to the computer 15 by means of a cable 15. The way the docking station 1 and the docking system 9 works will be explained in the following. It should be noted, that everywhere in the description the term “docking system” refers to a system comprising a “docking station” and another device which comprises a second short-range transceiver, which is able to communicate with the first short-range transceiver of the communication device, and which, is activated, when the telecommunication device is docked on/in the docking station 1. The term “headset system” refers to a headset, which may be corded, or wireless and which may or may not include a base.

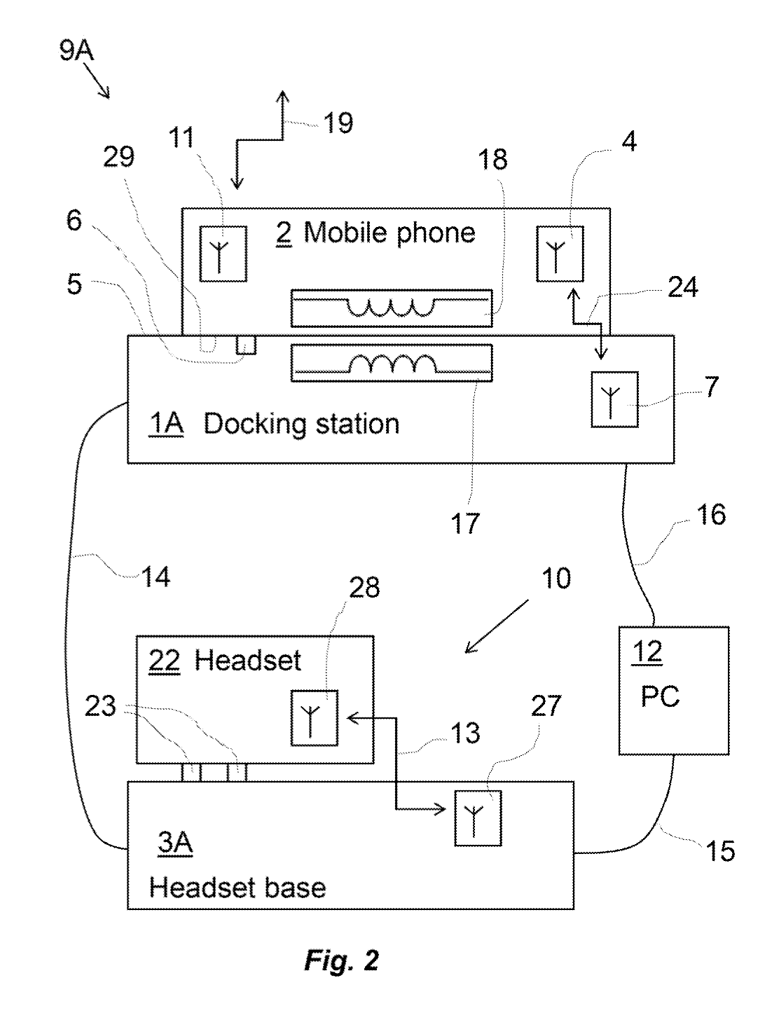

FIG. 2 is a diagram showing a docking station 1A according to a first embodiment and a docking system 9A according to a first embodiment. The docking station 1B comprises a flat top surface 5, a load sensor 6, an inductive charging transmitter circuit 17 and a Bluetooth transceiver 7. A mobile phone 2 is placed with its back side 29 on the top surface 5, which acts as a kind of “holder” for the mobile phone 2. The mobile phone 2 comprises a GSM transceiver 11, an inductive charging receiver circuit 18 and a Bluetooth transceiver 4. The GSM transceiver 11 is connected to the external communications network 21 by a GSM link 19. The load sensor 5 of the docking station 1A senses that the mobile phone 2 is lying on the top surface 5, which has activated the Bluetooth transceiver 7 whereby a Bluetooth link 24 is established to the Bluetooth transceiver 4 of the mobile phone 2. The load sensor 6 detects if the mobile phone 2 is removed from the docking station 1B again. If this is the case, the Bluetooth transceiver 7 of the docking station 1 is deactivated, whereby the connection 24 is broken. When the mobile phone 2 later is placed on the docking station 2 again, the load sensor 6 detects this and activates the Bluetooth transceiver 7 of the docking station 1, whereby the Bluetooth link 24 is re-established. This automatic procedure requires that the mobile phone 2 and the docking station 1A have been previously paired and that both devices are set to auto-connect when the other device is within range. A cable 14 connects the docking station 1A with the headset base 3A of headset system 10. The headset system 10 comprises the base 3A and a wireless headset 22. The cable 14 between the docking station 1A and the headset base 3A is routing audio in both directions and carries control signals for call handling etc. Thus, when the mobile phone 2 is placed on the docking station 1A the user can put on the headset 22, make and receive telephone calls with his hands free, as audio is routed between the mobile phone 2 and the headset system 10 via the docking station 1A. The docking station 1A also works as an inductive charger for the mobile phone 2. When the mobile phone 2 is placed on the docking station 1A, the inductive charging transmitter circuit 17 creates an inductive coupling with the inductive charging receiver circuit 18 of the mobile phone 2. The docking station 2 sends energy through this inductive coupling to the mobile phone 2 which stores the energy in a rechargeable battery, which is not shown here. The inductive charging receiver circuit 18 can be built into the mobile phone 2 or be attached as a receiver case to the mobile phone. Such receiver cases are sold under the brand “Powermat”.

The docking station 1B is also connected to the computer 12 via a cable 14. This cable 14 can be a USB-cable 14 providing power to the docking station 1A and providing presence status from the docking station 1A to the computer 12. Thus, when the mobile phone 2 is placed on the docking station 1A, the presence information on the computer is updated to “available”, whereby the users connections in the presence network can see, that the user is present at his computer. The presence status can be embodied intelligently such that “available”-presence is only sent if the Bluetooth link 24 is established. If the docking station 1B is embodied to be able to be paired with more than one telecommunication device 2, f. ex. two mobile phones belonging to two different users, only availability status of the relevant user may be sent to the computer.

In addition, the headset base 3A is connected to the computer 12 by means of a cable 15. This cable 15 may route audio between the headset system 10 and the computer 12, so that the user may make hands free IP telephony calls via the computer. The cable 15 may also provide power from the computer 12 to the headset base 3.

When the wireless headset 22 is cradled in the headset base 3A, there contact terminals 23 on the base 3A establishes electrical contact with not shown contact terminals on the headset 22 for charging purposes. The headset base 3A comprises a DECT transceiver 27 (DECT: Digital Enhanced Cordless Telecommunications) and the headset 22 comprises a corresponding DECT transceiver 28. When the headset 22 is removed from the headset base 3A a DECT link 13 is established between the headset 22 and the headset base 3A. However, the headset base transceiver 27 and the headset transceiver 28 could be Bluetooth transceivers or follow other radio standards.

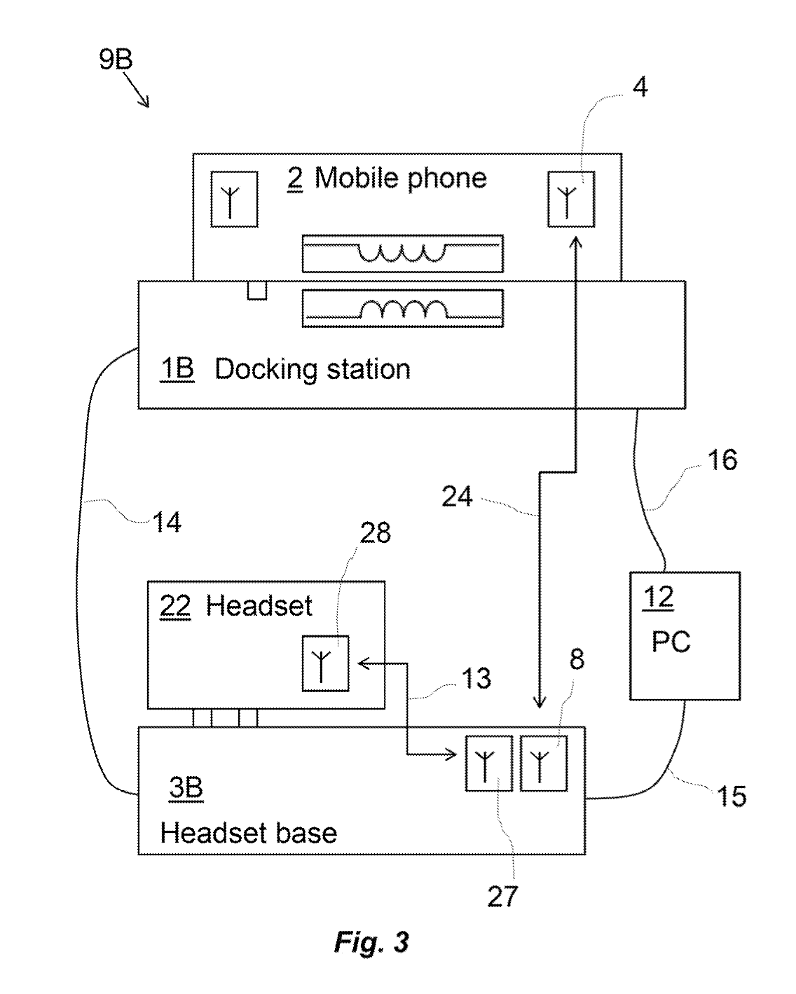

FIG. 3 is a diagram showing a docking station 1B according to a second embodiment and a docking system 9B according to a second embodiment. This second embodiment of the docking station 1B does not comprise the second short-range transceiver like the first embodiment of the docking station 1. Here, the headset base 3B comprises the second short-range transceiver 8, which is also a Bluetooth transceiver. When the load sensor 6 detects that the mobile phone 2 is placed on the docking station 2, it sends a control signal via the cable 14 to the headset base 3B to activate the Bluetooth transceiver 8. When the Bluetooth transceiver 8 of the headset base 3 is activated, a Bluetooth link 24 is established between the Bluetooth transceiver 4 of the mobile phone 2 and the Bluetooth transceiver 8 of the headset base 3B. Otherwise, the docking system 9B works in the same way as the first embodiment 9A shown in FIG. 1.

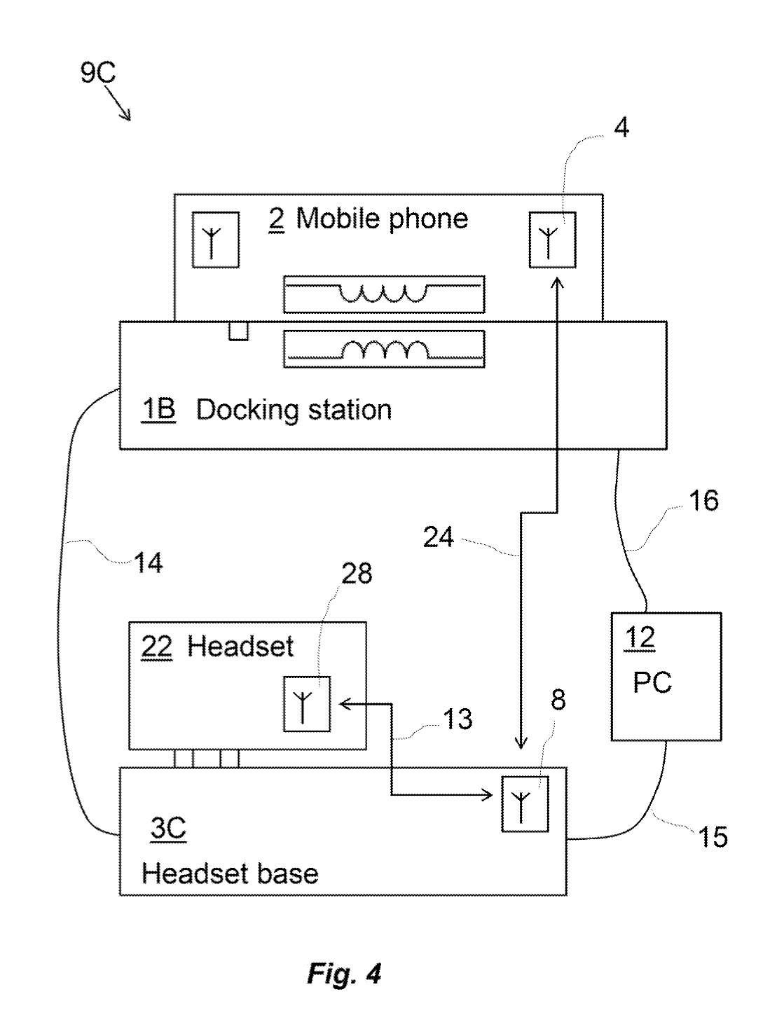

FIG. 4 is a diagram showing the second embodiment of the docking station 1B in a docking system 9C according to a third embodiment of the invention. This docking system 9C differs from the docking system 9B shown in FIG. 3 by the Bluetooth transceiver 8 of the headset base 3C also is used for providing a Bluetooth link with the headset 22, which is also provided with a Bluetooth transceiver 28.

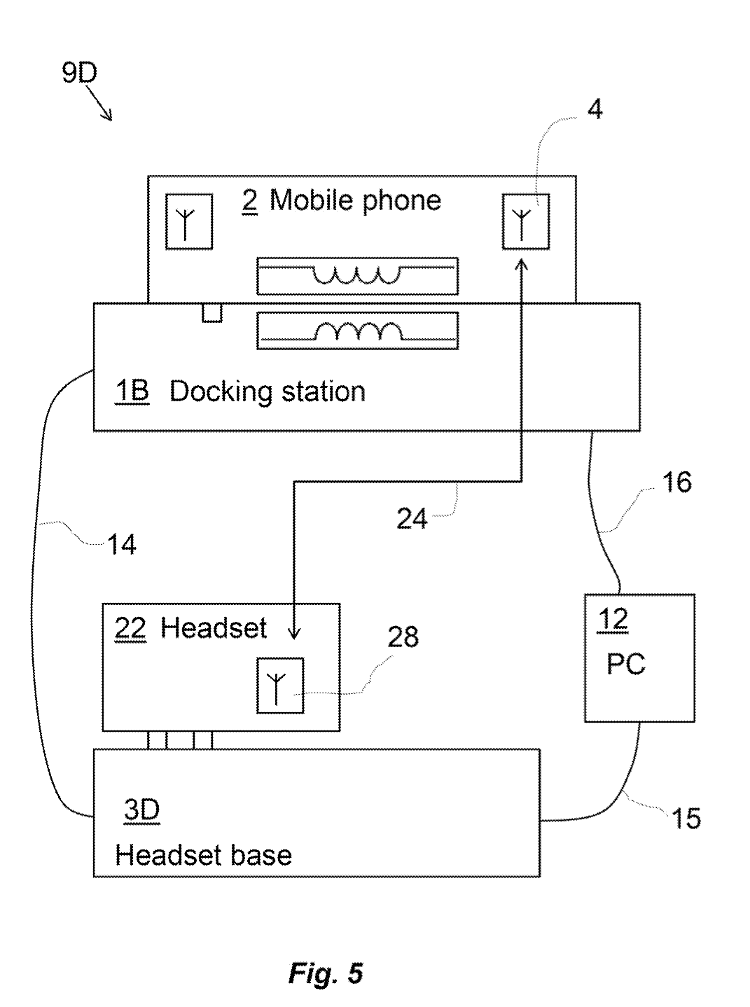

FIG. 5 is a diagram showing the second embodiment of the docking station 1B in a docking system 9D according to a fourth embodiment of the invention. Neither the docking station 1B nor the headset base 3B is provided with a transceiver. In stead, the Bluetooth transceiver 4 of the mobile phone 2 is creating a link 24 with a Bluetooth transceiver 28 of the headset 22. When the load sensor 6 detects that the mobile phone 2 is placed on the top surface 5 of the docking station 1B, a control signal is sent via the cable 14 to the headset base 3D and the headset 22 is informed via the charging contacts 23 to activate the headset transceiver 28, whereby the Bluetooth link 24 can be established. This means that the Bluetooth transceiver 28 of the headset 2 is always active when the mobile phone 2 is docked. However, activation of the Bluetooth transceiver 28 of the headset 22 requires, that the headset 22 is docked, as there is no radio link between the headset 22 and the headset base 3B.

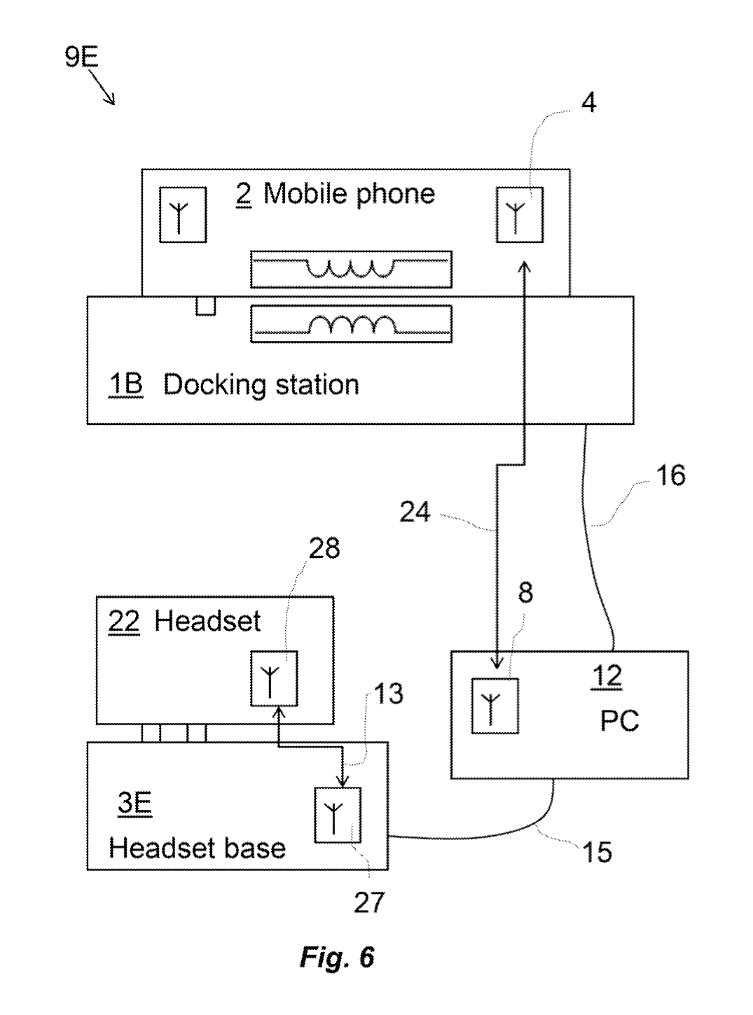

FIG. 6 is a diagram showing a docking station 1B according to the second embodiment and a docking system 9E according to a fifth embodiment. Here, the computer 12 comprises the second short-range transceiver 8, which is also a Bluetooth transceiver. When the load sensor 6 detects that the mobile phone 2 is placed on the docking station 2, it sends a control signal via the cable 16 to the computer 12 to activate the Bluetooth transceiver 8. When the Bluetooth transceiver 8 of computer 12 is activated, a Bluetooth link 24 is established between the Bluetooth transceiver 4 of the mobile phone 2 and the Bluetooth transceiver 8 of the computer. There is no cable between the docking station 1B and the headset base 3E. Control signals, audio and presence status is sent between the docking station 1B and the computer 12. Audio is routed between the computer 12 and the headset base 3E and between the headset base 3E and the headset 22 via the headset base transceiver 27 and the headset transceiver 28.

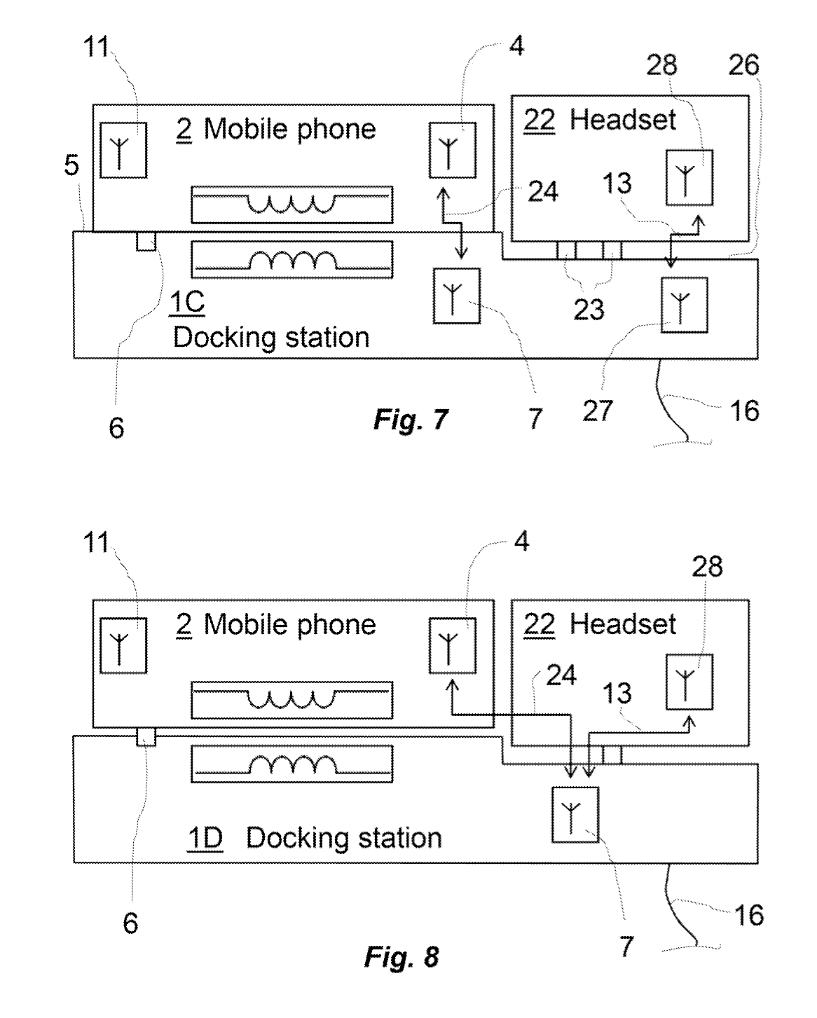

FIG. 7 is a diagram showing a docking station 1C according to a third embodiment of the invention. This docking station 1C comprises a headset cradle 26 for docking a wireless headset 22 with a headset transceiver 28. In addition, the docking station 1C comprises a second transceiver 7 and a base transceiver 27. The second transceiver 7 is a Bluetooth transceiver. The base transceiver 27 and the headset transceiver 28 may be Bluetooth transceivers, DECT transceivers or transceivers according to a third radio standard. When the mobile phone 2 is placed on the top surface 5 of the docking station 1C, the second transceiver 7 is activated whereby a Bluetooth link 24 is established. When the user removes the headset 22 from the cradle 26, a link between the headset transceiver 28 and the base transceiver 27 is established.

FIG. 8 is a diagram showing a docking station 1D according to a fourth embodiment of the invention. It differs from the docking station 1C according to the third embodiment 1C by having only one transceiver 7, which is a Bluetooth transceiver and which is able to simultaneously to communicate with both the Bluetooth transceiver 4 of the mobile phone 2 and the Bluetooth transceiver 28 of the headset 28.

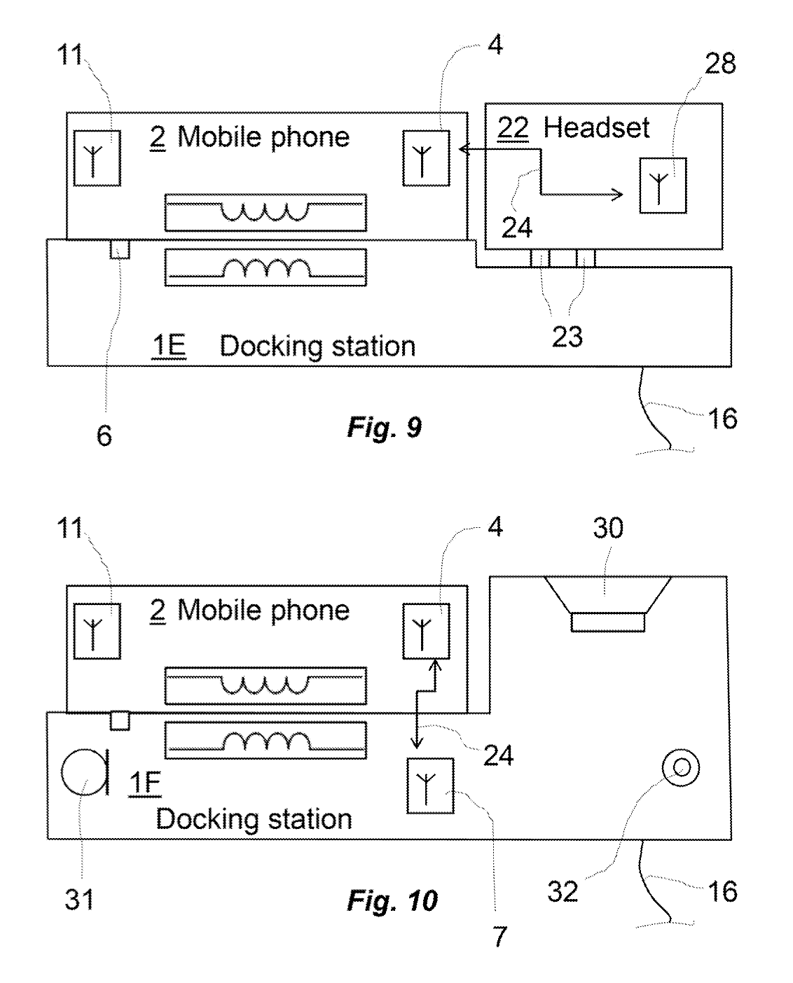

FIG. 9 is a diagram showing a docking station 1E according to a fifth embodiment of the invention. This docking station 1E differs from the fourth embodiment 1D by not having any transceivers. When the mobile phone 2 is placed on the top surface 5 of the docking station 1E, the headset 22 is via the contact terminals 23 instructed to activate its Bluetooth transceiver 28 whereby a Bluetooth link 24 is established directly between the Bluetooth transceiver 4 of the mobile phone 2 and the Bluetooth transceiver 28 of the headset 22. This means that the Bluetooth transceiver 28 of the headset 22 is always active when the mobile phone 2 is docked. However, activation of the Bluetooth transceiver 28 of the headset 22 requires, that the headset 22 is docked, as there is no radio link between the headset 22 and the docking station 1E.

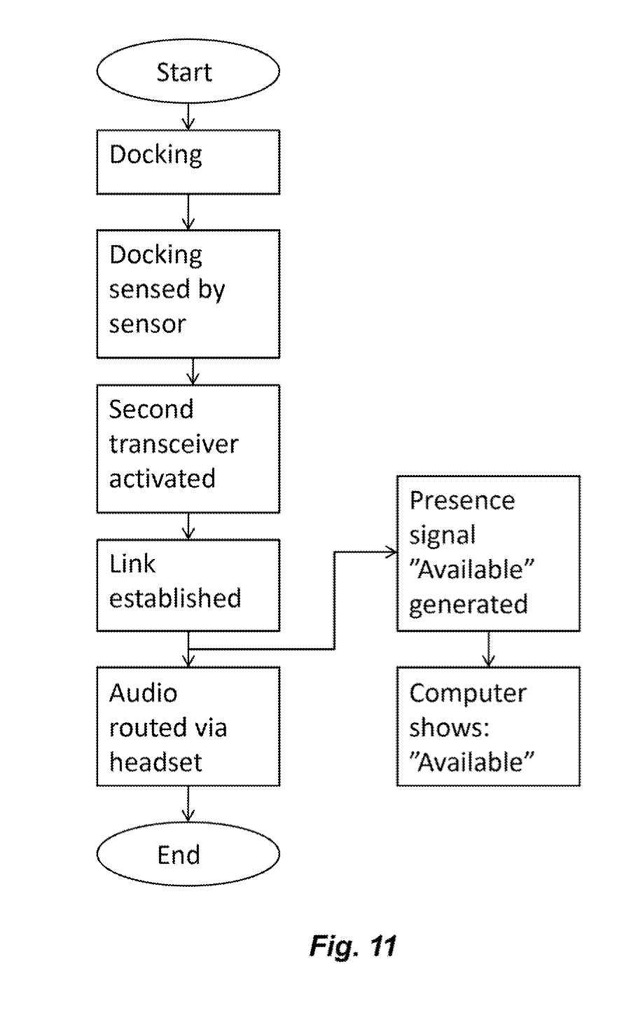

FIG. 10 is a diagram showing a docking station 1F according to a sixth embodiment of the invention. This embodiment comprises a second wireless transceiver 7, a speaker 30, a microphone 31 and an audio socket 32. This embodiment can work as a speakerphone or conferencing device which routes audio from the mobile phone 2 to the speaker 30 and audio from the microphone 31 to the mobile phone 2. When the mobile phone 2 is placed on the top surface 5 of the docking station 2, the Bluetooth transceiver 7 is activated whereby a link 24 is established between the Bluetooth transceiver 4 og the mobile phone 2 and the Bluetooth transceiver 7 of the docking station 1F. In a first mode audio is directed from the mobile phone 2 to the speaker 30 and from the microphone 31 to the mobile phone 2. In this mode several persons can participate in a telephone call. In another mode a corded headset can be plugged into the audio port 32, whereby a user can make hands free telecommunication. The docking station 1F may also be provided with means for playback stereo audio, whereby music stored on the handheld telecommunication device may be enjoyed people in the vicinity of the docking station.

FIG. 11 is a flowchart showing operation of the docking station/docking system when a telecommunication device is docked. When the user arrives at his desk, he will dock his mobile phone by laying it on the docking station. The load detector senses this and generates a signal, which causes the second transceiver, which can be located in the docking station or other device, such as a headset device connected to the docking station, to be activated. After the second transceiver has been activated, a link between the mobile phone and the second transceiver is automatically established. Now audio is routed to and from the mobile phone via the second transceiver. When the link is established, the presence signal “available” is sent to the computer, which now can inform the network that the user is present at his computer.

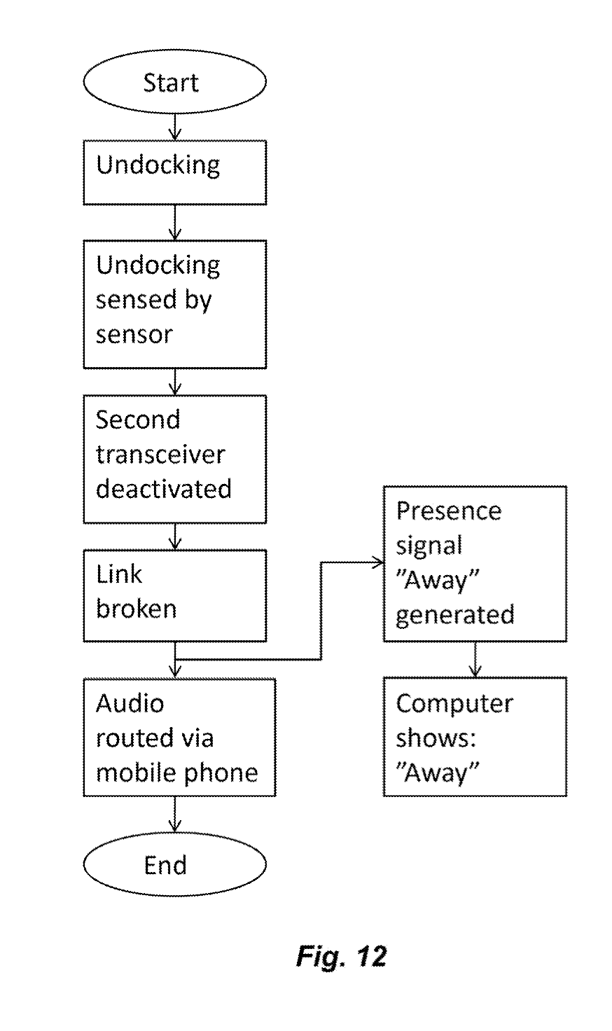

FIG. 12 is a flowchart showing operation of the docking station/docking system when a telecommunication device is undocked. When the user wants to leave his desk, he picks up his mobile phone, which is sensed by the load sensor. The link between the mobile phone and the second transceiver is broken and audio is routed to the mobile phones own speaker and from the mobile phones microphone. The presence signal “away” is sent to the computer, which can inform the network accordingly.

As mentioned earlier, only elements essential for explaining the invention are disclosed here. Other elements, which may be essential for functionality, but which are easy to implement for a skilled person, are left out for clarity reasons. Thus, processors, memory blocks, wirings, controllers etc. are left out.

The load sensor 6 can be embodied in many different ways. It can be a simple mechanical weight sensor, which is adapted to sense, that an object has been placed on the holder. Other simple means, such as optical sensors or mechanical levers could also be used. The top surface could also be provided with more than one load sensor, f. ex. an array of optical sensors in order to improve reliability such that a small particle dropped on the top surface would not activate the second transceiver.

As most modern mobile phones and smartphones are provided with Bluetooth connectivity, they can be used without any modifications with the docking station and docking system according to this invention. The user just has to pair his mobile phone or smartphone with the second transceiver and set the phone to auto-connect when the second short-range transceiver is detected. However, many modern handheld telecommunication devices including mobile phones and especially smartphones are also provided with a Wi-Fi transceiver, which follows the IEEE 802.11 specifications. The second short-range transceiver of the docking station or docking system according to the invention could be an IEEE 802.11 transceiver which activates and connects with the hand-held telecommunication device when this is held by the docking station.

In the embodiments shown here, a mobile phone 2 is used as an example of a handheld telecommunication device. However, handheld telecommunication devices such as smartphones, tablet computers and other handheld telecommunication devices, that are adapted to be carried by a user, can be used with the invention.

The term transceiver is used in this description and means a combination of a transmitter and a transceiver. This combination does not mean that the transmitter and the receiver must be combined in a single chip.

Mobile phones and other handheld telecommunication devices with Bluetooth transceivers normally act as masters when they are connected to devices such as headsets, which act as slaves. It is therefore likely that the Bluetooth transceiver 4 of the mobile phone 2 or alternative handheld telecommunication device is master and the headset 22 is slave in the shown embodiments. In the embodiments shown in FIGS. 2, 3, 6, 7 and 10 it is likely that the second transceiver 7; 8 is slave. In FIGS. 5 and 8 it is likely that the mobile phone transceiver 4 is master and the headset 22 is slave. In FIGS. 4 and 7 the second Bluetooth transceiver 7; 8 can act as a slave in the mobile phone link 24 and master in the headset link 13.

The docking station shown here is contactless as there is no galvanic contact between the telecommunication device and the docking station when the telecommunication device is docked. This is possible, as data and voice is transferred wirelessly and because the charging is inductive. However, the docking station could be provided with electrical contacts adapted to be engaged with corresponding contacts on the telecommunication device, whereby the latter could be recharged via these.

The term “docking station” used in this description could be replaced by other terms such as “cradle”, “holder”, “base”, “pad”, “docking pad” or the like.

The docking system according to the invention can also be used for giving authorization for a user to access programs on the computer. If the second transceiver is adapted to be paired with more than one telecommunication device by using the so-called multipoint technology, the access to the computer may be adapted to the specific mobile phone docked in the docking station.

### REFERENCE SIGNS

1 docking station
2 mobile phone
3 headset base
4 first short-range transceiver
5 top surface of docking station
6 load sensor
7 second short-range transceiver
8 second short-range transceiver
9 docking system
10 headset system
11 GSM transceiver
12 personal computer
13 second radio link (headset link)
14 first cable
15 second cable
16 third cable
17 inductive charging transmitter circuit
18 inductive charging receiver circuit
19 GSM link
20 telecommunication line
21 external communications network
22 headset
23 charging contacts
24 first radio link (phone Bluetooth link)
25 headset base display
26 headset cradle
27 base transceiver
28 headset transceiver
29 back side of mobile phone
30 speaker
31 microphone
32 audio socket

1. A docking station for a handheld telecommunication device, such as a mobile phone or a smartphone, which telecommunication device comprises a first short-range transceiver adapted to communicate according to a first radio standard, wherein the docking station comprises a holder for holding the telecommunication device and sensing means for detecting, that the telecommunication device is held by the holder, and wherein the docking station upon detecting that the telecommunication device is held by the holder provides an activating signal, which activates a second short-range transceiver according to the first radio standard, which second short-range transceiver is comprised by the docking station or a second device connected to the docking station.

2. A docking station according to claim 1, wherein the sensing means comprises a weight sensor, which is adapted to sense, that an object has been placed on the holder.

3. A docking station according to claim 1, wherein it is plate-shaped and comprises a top-surface adapted to support the entire back side of the telecommunication device.

4. A docking station according to claim 1, wherein it comprises an inductive charging transmitter circuit for charging a telecommunication device comprising a corresponding inductive charging receiver circuit, when the telecommunication device is supported by the holder.

5. A docking station according to claim 1, wherein the second short-range transceiver is comprised by the docking station.

6. A docking station according to claim 5, wherein it comprises an audio socket for output and/or input of audio signals, which are transmitted between the first short-range transceiver and the second short-range transceiver.

7. A docking station according to claim 5, wherein it comprises a speaker for emitting audio based on signals transmitted from the first short-range transceiver to the second short-range transceiver to audio.

8. A docking station according to claim 5, wherein it comprises a microphone for converting sound to an audio signal to be transmitted from the second short-range transceiver to the first short-range transceiver.

9. A docking station according to claim 5, wherein it comprises a headset cradle for docking a wireless headset with a headset transceiver.

10. A docking station according to claim 9, wherein the second short-range transceiver is adapted to simultaneously establish a first radio link with the first short-range transceiver and a second radio link the headset transceiver, such that two-way communication can be established between the telecommunication device and the headset.

11. A docking station according to claim 5, wherein the second short-range transceiver is a Bluetooth-transceiver, f. ex. a transceiver according to the “Bluetooth low energy” standard.

12. A docking system comprising a docking station according to claim 5 and a headset system, which headset system comprises a headset base and a wireless headset, and wherein the docking station and the headset base are electrically connected by a cable.

13. A docking system comprising a docking station according to claim 1 and a headset system, which headset system comprises a headset base and a wireless headset, wherein the second short-range transceiver is comprised by the headset system.

14. A docking system according to claim 13, wherein the second short-range transceiver is comprised by the headset base.

15. A docking system comprising a docking station according to claim 1, wherein the second short-range transceiver is comprised by a personal computer which is connected to the docking station by a cable.
